(19) United States
(12) Patent Application Publication
(10) Pub. No.: US 2011/0020112 A1
(43) Pub. Date: Jan. 27, 2011

(54) SEWAGE SEPERATION GENERATOR

(76) Inventor: Daniel Farb, Beith Shemesh (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/922,692

(22) PCT Filed: Mar. 12, 2009
(86) PCT No.: PCT/IB09/51038

§ 371 Date: Sep. 15, 2010

Related U.S. Application Data
(60) Provisional application No. 61/037,011, filed on Mar. 17, 2008.

(51) Int. Cl. F03B 11/00

(52) U.S. Cl. 415/169.1

(57) ABSTRACT

A system is presented that can partially separate solids from liquids and produce energy simultaneously.

This patent application claims the benefit of U.S. Provisional Patent Application No. 61/037,011, entitled Provisional 3-08 Slanted roof wind turbine Sewage turbine system and buoys, filed Mar. 17, 2008.

### FIELD AND BACKGROUND OF THE INVENTION

The present invention relates to a device and method for separating liquids from solids while simultaneously producing electricity. This is of particular value in sewage treatment, where recovery of water is of increasing importance.

### BRIEF DESCRIPTION OF THE DRAWINGS

The invention is herein described, by way of example only, with reference to the accompanying drawings, wherein:

FIG. 1 is a diagram of a system for separating solids and liquids with a turbine.

### DESCRIPTION OF THE PREFERRED EMBODIMENTS

The principles and operation of a solid/liquid separating generating system according to the present invention may be better understood with reference to the drawings and the accompanying description.

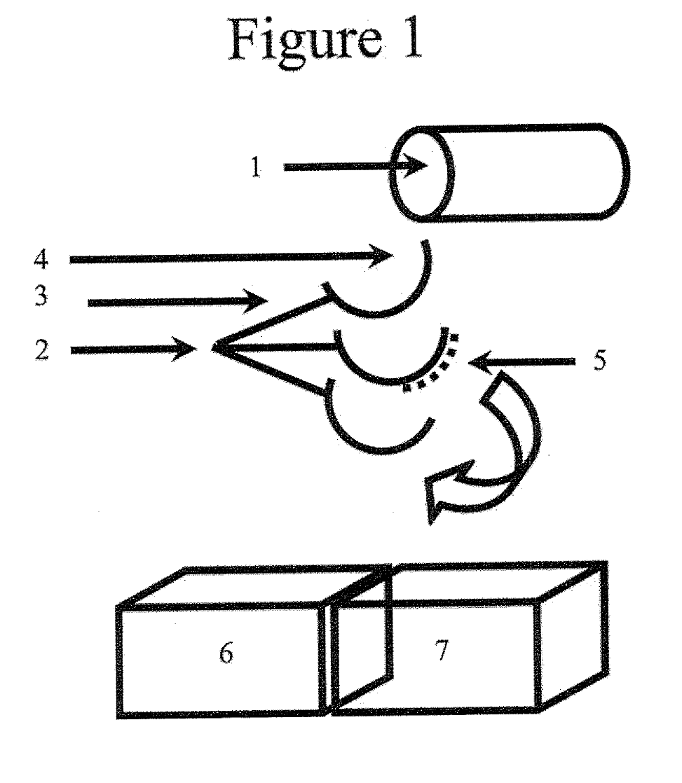

Referring now to the drawings, FIG. 1 illustrates such a system. An outlet pipe (1) carries a mixture of solid and liquid, typically sewage. The mixture falls onto a turbine with blades (4) that are ideally in the shape of cups. The purpose of this step is to have a means for separating solids from liquids. The blades are attached to arms (3) that rotate on a central shaft (2) that is ideally of lower elevation than the outlet and adjacent to the blades so that the effluent falls into the blades. The means can be a cupped blade receiving the sewage that has a sieve (5), such as a screen, perforation, filter, or net, to allow the fluids to flow out separately as the turbine rotates. The liquid can then pass initially into the liquid treatment system and the solids will fall off later. There will be a receptacle area for solids (6) and for liquids (7). This process can be repeated at least a second time for finer filtration.

An option is a non-stick inner surface to the cupped blades, such as Teflon, that prevents the solids from sticking to the turbine. Ideally, the turbine will be a slow rpm, high-torque machine. The method of adjusting the speed of revolution of the turbine to the nature of the solids is included.

In summary, the steps are: (1) separation of solids from liquids by at least one rotating turbine, (2) separate solid and liquid receptacles, (3) optional repetition of the process operating from the receptacles.

Another option is control of the outflow to work with the speed of the turbine and the nature of the mixture. For example, a thicker mixture would require a slower revolution.

The low-revolution shaft would ideally be attached to an adjustable gear, whether automatically adjustable or replaceable, that can accommodate changes in revolution speed easily. In particular, a gear that increases the rpm will enable a choice of higher rpm generators.

It is a given that this system will attach to a generator or other method of transferring the mechanical energy of rotation into another form of usable energy.

While the invention has been described with respect to a limited number of embodiments, it will be appreciated that many variations, modifications and other applications of the invention may be made.

### SUMMARY OF THE INVENTION

The present invention successfully addresses the shortcomings of the presently known configurations by providing a system and method to separate solids and liquids.

It is now disclosed for the first time a system for separating a mixture of liquids and solids, comprising:
a. an outlet for a flowing mixture of solid and liquid,
b. a turbine's blades operative to receive said flow.

In one embodiment, the system further comprises
c. a sieve attached to the blades of said turbine.

According to another embodiment, the axis of the turbine is at a lower elevation than the outlet.

According to another embodiment, the mixture is sewage.

According to another embodiment, the revolutions per minute (rpm) of the central shaft are less than 30 per minute.

According to another embodiment, the revolutions per minute (rpm) of the central shaft are less than 10 per minute.

In one embodiment, the system further comprises:
c. a receptacle substantially for fluids
d. a receptacle substantially for solids, wherein the fluids substantially fall into one receptacle and the solids into a separate receptacle.

In one embodiment, the system further comprises:
e. at least a second separation turbine.

According to another embodiment, the blades have a non-stick coating.

In one embodiment, the system further comprises:
c. a gear attached to the turbine's shaft.

According to another embodiment, the gear increases the rpm. According to another embodiment, the turbine's shaft is attached directly to a generator.

In one embodiment, the system further comprises:
c. a microprocessor control system operative to control parameters of the release of the mixture from the outlet.

It is now disclosed for the first time a method of at least partially separating solids and liquids by means of a turbine.

According to another embodiment, the solid/liquid mixture is sewage.

According to another embodiment, the turbine blades comprise a filter.

According to another embodiment, the turbine has an rpm of less than 30.

According to another embodiment, the turbine's shaft is attached to an adjustable gear and then optionally to a generator.

According to another embodiment, the turbine's shaft is attached directly to a generator.

It is now disclosed for the first time a method of adapting the characteristics of a solid/liquid separating turbine system to the thickness of the mixture so that so that at least 10% of the liquid is separated with each revolution.

According to another embodiment, the result is obtained by adjusting the rpm of the turbine.

What is claimed is:

1-21. (canceled)

22. A system for separating a mixture of liquids and solids, comprising:
a. An outlet for a flowing mixture of solid and liquid,
b. A turbine's blades operative to receive said flow by means of gravity.

23. The system of claim 22, further comprising:
c. A sieve attached to the blades of said turbine.

24. The system of claim 22, wherein the axis of the turbine is at a lower elevation than the outlet.

25. The system of claim 22, wherein the mixture is sewage.

26. The system of claim 22, wherein the revolutions per minute (rpm) of the central shaft are less than 30 per minute.

27. The system of claim 26, wherein the revolutions per minute (rpm) of the central shaft are less than 10 per minute.

28. The system of claim 22, further comprising:
c. A receptacle substantially for fluids
d. A receptacle substantially for solids, wherein the fluids substantially fall into one receptacle and the solids into a separate receptacle.

29. The system of claim 28, further comprising:
e. At least a second separation turbine.

30. The system of claim 22, wherein the blades have a non-stick coating.

31. The system of claim 22, further comprising:
c. A gear attached to the turbine's shaft, wherein the gear increases the rpm.

32. The system of claim 22, further comprising:
c. A microprocessor control system operative to control parameters of the release of the mixture from the outlet.

33. A method of at least partially separating solids and liquids by means of a gravity-operated turbine whose blades accept a mixed fluid from an outlet.

34. The method of claim 33, wherein the solid/liquid mixture is sewage.

35. The method of claim 33, wherein the turbine blades comprise a filter.

36. The method of claim 33, wherein the turbine's shaft is attached to an adjustable gear.

37. A method of adapting the characteristics of a solid/liquid separating turbine system by means of a gravity-operated turbine whose blades accept a mixed fluid from an outlet to the thickness of the mixture so that at least 10% of the liquid is separated with each revolution.

38. The method of claim 37, wherein the result is obtained by adjusting the rpm of the turbine.
